(19) United States
(12) Patent Application Publication
(10) Pub. No.: US 2009/0082498 A1
(43) Pub. Date: Mar. 26, 2009

(54) ROOM TEMPERATURE CURABLE ORGANOPOLYSILOXANE COMPOSITION

(75) Inventor: Tsuneo KIMURA, Annaka-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 12/212,084

(22) Filed: Sep. 17, 2008

(30) Foreign Application Priority Data
Sep. 21, 2007 (JP) 2007-244936

(51) Int. Cl. C08K 3/36; C08K 5/5445; C08K 5/5419

(52) U.S. Cl. 524/188; 524/80; 524/443; 524/268

(57) ABSTRACT

A room temperature curable organopolysiloxane composition is provided. This composition comprises
(A) a diorganopolysiloxane endcapped at both ends of the molecular chain with hydroxy group represented by the following formula:

HO—(R₂SiO)ₙ—H

wherein R represents a monovalent hydrocarbon group, and n represents an integer of at least 10,
(B) an organopolysiloxane comprising R¹₃SiO_{1/2} unit, R¹₂SiO_{2/2} unit, and R¹SiO_{3/2} unit wherein R¹ represents a monovalent hydrocarbon group, and SiO_{4/2} unit with the proviso that molar ratio of R¹₃SiO_{1/2} unit to SiO_{4/2} unit is in the range of 0.6 to 1.2, molar ratio of R¹₂SiO_{2/2} unit to SiO_{4/2} unit and molar ratio of R¹SiO_{3/2} unit to SiO_{4/2} unit are both in the range of 0 to 1.0, and content of the silanol group is less than 1.5% by weight,
(C) surface treated fumed silica,
(D) a silane and/or its hydrolysate containing at least two hydrolyzable groups in the molecule, and
(E) a curing catalyst.

### CROSS-REFERENCE TO RELATED APPLICATION

This non-provisional application claims priority under 35 U.S.C. §119(a) on Patent Application No. 2007-244936 filed in Japan on Sep. 21, 2007, the entire contents of which are hereby incorporated by reference.

### TECHNICAL FIELD

This invention relates to a room temperature curable organopolysiloxane composition which is useful as a silicone-based sealant, adhesive, coating composition, or potting agent, and more specifically, to a room temperature curable organopolysiloxane composition which cures by condensation and which exhibits excellent curability as well as high temperature sensibility (namely, showing rapid decrease in the viscosity or softening with increase in the temperature), enabling its use as a silicone-based reactive hot melt material.

### BACKGROUND OF THE INVENTION

Conventional condensation-curable room temperature rapid-curing organopolysiloxane compositions include one part-type compositions in which amount of the crosslinking agent has been reduced to the minimum level to thereby increase the speed of crosslinking by hydrolysis, and the two part-type compositions in which the crosslinking agent and the curing agent have been separately packaged. However, the one part-type composition does not really have a rapid curability since it only exhibits high curing speed on its surface, and a considerable time is required for the depth curing. The two part-type composition, on the other hand, has the drawback of poor handling convenience since the two parts cannot be mixed at a ratio of 1:1, and it is not adapted for use in an automatic mixer despite its relatively high depth curability. Furthermore, in order to accomplish complete curing to the full depth, a strict control in the amount of the crosslinking agent and the curing agent added, or alternatively, an addition of water as an depth curing agent was necessary. In the meanwhile, an addition curable organopolysiloxane composition requires a heated furnace for its curing although it has improved workability since the two parts can be mixed at a ratio of 1:1. The addition curable organopolysiloxane composition also has the drawback that the working conditions are limited since the curing catalyst is poisoned in the presence of an addition poison.

One solution that has been proposed is to impart the composition with temperature sensibility. In this case, viscosity of the composition is reduced before its use by elevating the temperature, and then, the viscosity is increased by returning to room temperature so that green strength is increased to thereby acquire apparent curability. In contrast to the rubber formation by chemical reaction, this change is a phase change realized by temperature change, and such phase change is characterized by the apparently fast curing. A mixture of a silicone oil and a silicone resin has been known to have temperature sensibility, and Japanese Patent Application Laid-Open No. H2-163181 proposes a mixture of a silicone oil and a silicone resin containing a particular ester compound. However, this composition suffers from the problem that it does not have reactivity, and becomes liquid when heated again. In order to obviate this problem, reactivity should be imparted with the temperature sensibile composition. Japanese Patent Publication No. H7-119395 (Japanese Patent Application Laid-Open No. H4-81487) proposes a mixture comprising a silicone oil having a hydrolyzable group, a silicone resin, and a curing catalyst, and Japanese Patent Application Laid-Open No. H7-70516 proposes a method for using a mixture comprising a silicone oil having a hydrolyzable group and a silicone resin. Japanese Patent Application Laid-Open No. H7-70541 proposes use of an oxime silane as a crosslinking agent, and Japanese Patent Application Laid-Open No. H7-53871 proposes a similar composition prepared by using a siloxane having amino group as a hydrolyzable group.

### DISCLOSURE OF THE INVENTION

However, these compositions share the drawback that the cured products obtained by curing the composition also exhibits temperature sensibility. While they do not become liquid by the re-heating, they ooze out from the site of sealing or adhesion, and become melted. In order to solve this problem, a composition is required which has temperature sensibility before the curing but which retains the shape after the curing even if heated.

Accordingly, an object of the present invention is to provide a room temperature curable organopolysiloxane composition which exhibits high temperature sensibility, and after curing, which can retain the shape at high temperature.

The inventors of the present invention have made an intensive study to obviate the problems as described above, and found that addition of fumed silica, and in particular, the fumed silica having hydrophobicized surface is effective for retaining the shape at high temperature. The inventors further investigated the type and amount of such fumed silica, and the present invention has been accomplished on the bases of such efforts.

Accordingly, the present invention provides a room temperature curable organopolysiloxane composition having high curability and temperature sensibility as well as high shape retainability at high temperature, and this room temperature curable organopolysiloxane composition comprises

(A) 30 to 70 parts by weight of a diorganopolysiloxane endcapped at both ends of the molecular chain with hydroxy group represented by the following formula:

HO—(R₂SiO)ₙ—H

wherein R independently represents an unsubstituted or substituted monovalent hydrocarbon group, and n represents an integer of at least 10,

(B) 70 to 30 parts by weight of an organopolysiloxane comprising R¹₃SiO_{1/2} unit, R¹₂SiO_{2/2} unit, and R¹SiO_{3/2} unit wherein R¹ independently represents an unsubstituted or substituted monovalent hydrocarbon group containing 1 to 6 carbon atoms, and SiO_{4/2} unit with the proviso that molar ratio of R¹₃SiO_{1/2} unit to SiO_{4/2} unit is in the range of 0.6 to 1.2, molar ratio of R¹₂SiO_{2/2} unit to SiO_{4/2} unit and molar ratio of R¹SiO_{3/2} unit to SiO_{4/2} unit are both in the range of 0 to 1.0, and content of the silanol group is less than 1.5% by weight,

(C) 2 to 50 parts by weight of surface treated fumed silica in relation to 100 parts by weight in total of the component (A) and component (B),

(D) 1 to 30 parts by weight of a silane and/or its hydrolysate containing at least two hydrolyzable groups in the molecule in relation to 100 parts by weight in total of the component (A) and component (B), and

(E) 0.01 to 10 parts by weight of a curing catalyst in relation to 100 parts by weight in total of the component (A) and component (B).

In this case, the surface treating agent used in preparing the surface treated fumed silica (C) is preferably the one selected from chlorosilane, silazane, and siloxane, and the surface treated fumed silica preferably has a specific surface area of 50 to 300 m²/g. The hydrolyzable group in the silane and/or its hydrolysate (D) containing at least two hydrolyzable groups in the molecule is preferably an alkenoxy group.

### EFFECTS OF THE INVENTION

The room temperature curable organopolysiloxane composition of the present invention has excellent curability and temperature sensibility as well as excellent shape retainability at high temperature.

### Description of the Preferred Embodiments

The room temperature curable organopolysiloxane composition of the present invention contains the following components (A) to (E) as critical components.

### Component (A)

Component (A) is a diorganopolysiloxane endcapped at both ends of the molecular chain with hydroxy group as represented by the following formula:

HO—(R₂SiO)ₙ—H.

This component is the base polymer of the present composition.

In this general formula, R independently represents an unsubstituted or substituted monovalent hydrocarbon group such as an alkyl group containing 1 to 20 carbon atom, and more preferably 1 to 8 carbon atoms, an alkenyl group containing 2 to 20 carbon atoms, and more preferably 2 to 8 carbon atoms, an aryl group containing 6 to 20 carbon atoms, and more preferably, 6 to 12 carbon atoms, and any of these hydrocarbon groups having some or all of the hydrogen atoms substituted with a halogen atom such as fluorine. Exemplary alkyl groups include methyl group, ethyl group, propyl group, and cyclohexyl group; and exemplary alkenyl groups include vinyl group and allyl group. Exemplary aryl groups include phenyl group, and exemplary halogen atoms include 3,3,3-trifluoropropyl group. Among these, the preferred are methyl group, vinyl group, and phenyl group, and the most preferred is methyl group.

In the general formula, n is an integer of at least 10 which is selected so that the diorganopolysiloxane has a viscosity at 25° C. of preferably 10 to 1,000,000 mPa·s, more preferably 100 to 100,000 mPa·s, and most preferably 300 to 50,000 mPa·s. An excessively low viscosity may result in the insufficient mechanical properties of the cured product while an excessively high viscosity may result in the unduly increased viscosity of the composition, which in turn results in the loss of workability. In the present invention, viscosity is the value measured by a rotary viscometer.

### Component (B)

Component (B) is an organopolysiloxane comprising R¹₃SiO_{1/2} unit, R¹₂SiO_{2/2} unit, and R¹SiO_{3/2} unit wherein R¹ independently represents an unsubstituted or substituted monovalent hydrocarbon group containing 1 to 6 carbon atoms, and SiO_{4/2} unit with the proviso that molar ratio of R¹₃SiO_{1/2} unit to SiO_{4/2} unit is in the range of 0.6 to 1.2, molar ratio of R¹₂SiO_{2/2} unit to SiO_{4/2} unit and molar ratio of R¹SiO_{3/2} unit to SiO_{4/2} unit are both in the range of 0 to 1.0, and content of the silanol group is less than 1.5% by weight.

As described above, R¹ represents an unsubstituted or substituted monovalent hydrocarbon group containing 1 to 6 carbon atoms, and exemplary such R¹ include alkyl groups such as methyl group, ethyl group, propyl group, isopropyl group, and hexyl group, cycloalkyl groups such as cyclohexyl, alkenyl groups such as cycloalkyl group, vinyl group, allyl group, and propenyl group, and aryl groups such as alkenyl group, and any of these groups having a part or all of the hydrogen atoms substituted with a halogen atom or the like such as chloromethyl group and 3,3,3-trifluoropropyl group.

In the component (B), molar ratio of the R¹₃SiO_{1/2} unit to the SiO_{4/2} unit is in the range of 0.6 to 1.2 and preferably in the range of 0.7 to 1.1. When this molar ratio is less than 0.6, solubility in component (A) will be reduced, and the molar ratio in excess of 1.2 will result in the insufficient temperature sensibility. The organopolysiloxane of the component (A) preferably comprises solely the R¹₃SiO_{1/2} unit and the SiO_{4/2} unit. However, the organopolysiloxane may also include the R¹₂SiO_{2/2} unit and/or the R¹SiO_{3/2} unit at an amount such that the molar ratio of such units to the SiO_{4/2} unit is respectively in the molar ratio of up to 1.0, and preferably up to 0.8. When the R¹₂SiO_{2/2} unit or the R¹SiO_{3/2} unit is included at an amount in excess of such range, the temperature sensibility will be insufficient.

It is also necessary that the silanol group in the organopolysiloxane of the component (B) is less than 1.5% by weight, preferably up to 1.0% by weight, and more preferably up to 0.7% by weight or none (i.e. 0%). When the silanol group is present at an amount of 1.5% by weight or higher, the resulting composition will suffer from unsatisfactory rubber modulus. The content of the silanol group is the content of the OH group bonded to the silicon atom.

The organopolysiloxane of the component (B) is produced by simultaneously hydrolyzing and condensing a monofunctional triorganosilane having one hydrolyzable group with a tetrafunctional silane which has been substituted with four hydrolyzable groups in an organic solvent, and this organopolysiloxane of the component (B), which is a known material, is substantially free from the volatile component. The organic solvent used in the simultaneous hydrolysis is preferably the one which is capable of dissolving the generated organopolysiloxane (the component (A)), and typical organic solvents include toluene, xylene, methylene chloride, and naphtha mineral spirit.

The components (A) and (B) are used so that the component (A) comprises 30 to 70 parts by weight, and preferably 50 to 70 parts by weight, and the component (B) comprises 70 to 30 parts by weight, and preferably 50 to 30 parts by weight, with the total of the components (A) and (B) being 100 parts by weight. When the component (A) is less than 30 parts by weight, (namely, when the component (B) is in excess of 70 parts by weight), temperature sensibility before the curing of the composition will be reduced. In contrast, when the content of the component (A) is in excess of 70 parts by weight (namely, when the content of the component (B) is less than 30 parts by weight), viscosity of the composition at room temperature will be unduly high, detracting from workability.

### Component (C)

The surface treated fumed silica of the component (C) is the component which imparts the present composition with the shape retainability at high temperature. The surface treatment improves dispersibility of this component, and hence, homogeneous dispersion of this component in the components (A) and (B), and the interaction between the surface treated fumed silica components, and the interaction between the surface treated fumed silica with the components (A) and (B) imparts the composition with improved shape retainability at high temperature after its curing.

Effective surface treating agents include chlorosilane, silazane, and siloxane, and exemplary surface treating agents include methyltrichlorosilane, dimethyldichlorosilane, trimethylchlorosilane, hexamethyldisilazane, octamethyl cyclotetrasiloxane, and α,ω-trimethylsilyldimethylpolysiloxane.

The component (C) may have specific surface area (measured by BET method) of 50 to 300 m²/g, and preferably 100 to 200 m²/g. At less than 50 m²/g, surface retainability at high temperature will be insufficient and, while the specific surface area in excess of 300 m²/g results in an unduly high viscosity before the curing of the composition, and hence, low workability.

The component (C) is added at an amount of 2 to 50 parts by weight, and preferably 3 to 20 parts by weight in relation to 100 parts by weight in total of the components (A) and (B). At an amount less than 2 parts by weight, shape retainability at high temperature will be insufficient while amount in excess of 50 parts by weight results in the increased viscosity of the composition before the curing, and hence, reduced workability.

### Component (D)

The silane and/or its hydrolysate containing at least two hydrolyzable groups in the molecule of the component (D) functions as a curing agent of the present composition.

Examples of the component (D) include silanes, for example, ketoxime silanes such as methyltris(dimethylketoxime)silane, methyltris(methylethylketoxime)silane, ethyltris(methylethylketoxime)silane, methyltris(methylisobutylketoxime)silane, and vinyltris(methylethylketoxime)silane; and alkoxysilanes such as methyltrimethoxysilane and vinyltrimethoxysilane, alkenoxysilanes such as methyltriisopropenoxysilane and phenyltriisopropenoxysilane, and acetoxysilanes such as methyltriacetoxysilane and vinyltriacetoxysilane; as well as hydrolysis and condensation products of one or more of these silanes. Of these, the preferred are those in which the hydrolyzable group is an alkenoxy group.

The component (D) is incorporated at an amount of 1 to 30 parts by weight in relation to 100 parts by weight in total of the component (A) and component (B). When incorporated at less than 1 part by weight, crosslinking will be insufficient and the cured product will have an insufficient rubber elasticity, while incorporation in excess of 30 parts by weight will result in insufficient mechanical properties. Preferably, the component (D) is incorporated at an amount of 1 to 20 parts by weight.

### Component (E)

The curing catalyst of component (E) functions in the composition of the present invention as a catalyst for the condensation between the component (A) and the component (B). Examples of the component (E) include tin catalysts such as tin octoate, dimethyltin diversatate, dibutyldimethoxytin, dibutyltin diacetate, dibutyltin dioctoate, dibutyltin dilaurate, dibutyltin dibenzylmaleate, dioctyltin dilaurate, and tin chelate; strong basic compounds such as guanidine, and 1,8-diazabicyclo[5.4.0]-7-undecene (DBU); alkoxysilanes having such group; titanate ester or titanium chelate compound such as tetraisopropoxy titanium, tetra-n-butoxy titanium, tetrakis(2-ethylhexoxy)titanium, dipropoxy bis(acetylacetonate) titanium, and titanium isopropoxy octylene glycol. The preferred are tin catalysts. The curing catalyst of component (E) may be used as a single compound or a mixture of two or more compounds.

The component (E) is incorporated at 0.01 to 10 parts by weight, and preferably at 0.02 to 5 parts by weight in relation to 100 parts by weight of the total of the components (A) and (B). Curing properties will be insufficient at the amount less than 0.01 parts by weight, and incorporation in excess of 10 parts by weight will result in the loss of durability of the composition.

### Other Components

In addition to the components as described above, the composition of the present invention may also have incorporated therein additives known in the art as adequate for incorporating in the room temperature curable organopolysiloxane composition. Exemplary such additives include reinforced/non-reinforced fillers such as wet silica, sedimentary silica, and calcium carbonate; metal oxides such as aluminum oxide and aluminum hydroxide; and carbon black, glass beads, glass balloon, resin beads, and resin balloon. These fillers may be optionally treated by a known surface treating agent. The composition may also include a silane coupling agent as a tackifier component, a polyether as a thixotropic agent, and a non-reactive dimethylsilicone oil as a plasticizer. If desired, the composition may also include a colorant such as a pigment, a dye, or a fluorescent brightening agent; or a bioreactive additive such as a fungicide, an antibacterial agent, a cockroach repellent, or an antifouling agent.

### Preparation and Curing of the Composition

The room temperature curable organopolysiloxane composition of the present invention can be produced by homogeneously mixing the components (A) to (E) in a kneader of the type known in the art such as a planetary mixer to produce a one part composition. The component (B) which is solid is generally produced as a solution in a solvent such as toluene. When the solvent is removed after mixing this component (B) with the component (A), the material can be prepared in a form free from the solvent. Since the composition of the present invention is to be used by elevating the temperature before its use in order to reduce the viscosity, it is natural that the product is formed in a form free from the solvent. The resulting mixture of the components (A) and (B) is stable since it does not exhibit reactivity. The components (C), (D), and (E) may be added to this mixture, and the resulting mixture may be homonegeously mixed in a kneader of the type known in the art such as a planetary mixer to produce a one part composition.

The curing may be accomplished generally by leaving the composition at room temperature (5 to 40° C.) for 1 to 7 days, and in this case, the composition is preferably heated in order reduce its viscosity before the curing, to a temperature in the range of 50 to 150° C., and in particular, 70 to 120° C. After such temperature elevation, the composition may be allowed to cool or cooled to room temperature.

### Applications of the Composition

The room temperature curing organopolysiloxane composition of the present invention is well adapted for use as a sealant, adhesive, coating agent, and potting agent, and in particular, for realizing a process without requiring a holding jig and for reducing the takt time in a production line since improved workability can be realized by using the composition after reducing its viscosity by elevating the temperature, and the viscosity can be increased again after its use by allowing it to cool or by forcedly cooling the composition to realize apparent curability. After the final curing by condensation, the cured composition exhibits shape retainability even at high temperature, and accordingly, this composition can be used at a site which will be exposed to a high temperature where conventional compositions had been inapplicable.

### EXAMPLES

Next, the present invention is described in further detail by referring to the following Examples and Comparative Examples which by no means limit the scope of the present invention. In the following Examples and Comparative Examples, viscosity is the value measured by a rotary viscometer at 25° C.

### Synthetic Example 1

70 parts by weight of dimethylpolysiloxane polymer endcapped at both end of the molecular chain with hydroxysilyl group having a viscosity at 25° C. of 20,000 Pa·s, and 60 parts by weight (solid content, 30 parts by weight) of resinous siloxane copolymer comprising (CH₃)₃SiO_{1/2} (trimethylsiloxy) unit and SiO_{4/2} unit at a molar ratio of (CH₃)₃SiO_{1/2}/SiO_{4/2} of 0.74, having silanol group content of 0.06 mol/100 g (1.0% by weight) which had been dissolved in toluene at a solid content of 50% by weight were homogeneously mixed with agitation, and toluene was removed by heating the mixture to 80° C. to prepare Synthetic product 1.

### Example 1

8 parts by weight of fumed silica (Aerosil R974 manufactured by Nippon Aerosil) having a specific surface area of 170 m²/g which had been surface treated with dimethyldichlorosilane was added to 100 parts by weight of the Synthetic product 1, and the mixture was kneaded in a planetary mixer at normal pressure for 10 minutes, and under reduced pressure for 20 minutes. 6 parts by weight of vinyltriisopropenoxysilane, 0.7 parts by weight of tetramethylguanidylpropyltrimethoxysilane, and 0.5 parts by weight of γ-aminopropyltriethoxysilane were then added, and the mixture was kneaded under reduced pressure for 15 minutes to prepare Composition 1.

### Example 2

8 parts by weight of fumed silica (Aerosil R974 manufactured by Nippon Aerosil) having a specific surface area of 170 m²/g which had been surface treated with dimethyldichlorosilane was added to 100 parts by weight of the Synthetic product 1, and the mixture was kneaded in a planetary mixer at normal pressure for 10 minutes, and under reduced pressure for 20 minutes. 6 parts by weight of vinyltrimethylethyl ketoxime silane, 0.1 parts by weight of dioctyltin dilaurate, and 1 parts by weight of γ-aminopropyltriethoxysilane were then added, and the mixture was kneaded under reduced pressure for 15 minutes to prepare Composition 2.

### Example 3

8 parts by weight of fumed silica (Aerosil R974 manufactured by Nippon Aerosil) having a specific surface area of 170 m²/g which had been surface treated with dimethyldichlorosilane was added to 100 parts by weight of the Synthetic product 1, and the mixture was kneaded in a planetary mixer at normal pressure for 10 minutes, and under reduced pressure for 20 minutes. 4 parts by weight of vinyltrimethoxysilane, 3 parts by weight of tetrakis(2-ethylhexoxy) titanium, and 0.5 parts by weight of γ-glycidoxypropyltrimethoxysilane were then added, and the mixture was kneaded under reduced pressure for 15 minutes to prepare Composition 3.

### Comparative Example 1

6 parts by weight of vinyltriisopropenoxysilane, 0.7 parts by weight of tetramethylguanidylpropyltrimethoxysilane, and 0.5 parts by weight of γ-aminopropyltriethoxysilane were added to 100 parts by weight of the Synthetic product 1, and the mixture was kneaded under reduced pressure for 15 minutes to prepare Composition 4.

The resulting composition was placed in a metal tube, and heated to 80° C. In an environment of 23° C., the composition was formed into a sheet having a thickness of 2 mm, and the sheet was allowed to cure in an atmosphere of 23±2° C. at a relative humidity of 50±5% for 7 days. The resulting cured sheet was cut into squares of 3 cm×3 cm, and placed on an aluminum dish. After leaving the sheet in a drier kept at predetermined temperature for 7 days, shape of the sheet was examined. The results are shown in Table 1.

TABLE 1

| | | | | Comparative |
|---|---|---|---|---|
| | Example 1 | Example 2 | Example 3 | Example 1 |
| | Composition | Composition | Composition | Composition |
| | 1 | 2 | 3 | 4 |
| 23° C. | Shape | Shape | Shape | Shape |
| | retained | retained | retained | retained |
| 50° C. | Shape | Shape | Shape | Shape |
| | retained | retained | retained | retained |
| 100° C. | Shape | Shape | Shape | Deformed |
| | retained | retained | retained | |
| 150° C. | Shape | Shape | Shape | Melted and |
| | retained | retained | retained | flowed away |
| 200° C. | Shape | Shape | Shape | Melted and |
| | retained | retained | retained | entirely lost |
| | | | | its shape |

### Synthetic Example 2

50 parts by weight of dimethylpolysiloxane polymer endcapped at both end of the molecular chain with hydroxysilyl group having a viscosity at 25° C. of 20,000 Pa·s, and 100 parts by weight (solid content, 50 parts by weight) of resinous siloxane copolymer comprising CH₂═CH(CH₃)₂SiO_{1/2} (vinyldimethylsiloxy) unit and SiO_{4/2} unit at a molar ratio of CH₂═CH(CH₃)₂SiO_{1/2}/SiO_{4/2} of 0.75, having silanol group content of 0.03 mol/100 g (0.5% by weight) which had been dissolved in xylene at a solid content of 50% by weight were homogeneously mixed with agitation, and xylene was removed by heating the mixture to 80° C. to prepare Synthetic product 2.

### Example 4

10 parts by weight of fumed silica (Aerosil R972 manufactured by Nippon Aerosil) having a specific surface area of 110 m²/g which had been surface treated with dimethyldichlorosilane was added to 100 parts by weight of the synthetic product 2, and the mixture was kneaded in a planetary mixer at normal pressure for 10 minutes, and under reduced pressure for 20 minutes. 6 parts by weight of vinyltriisopropenoxysilane, 0.7 parts by weight of tetramethylguanidylpropyltrimethoxysilane, and 0.5 parts by weight of γ-aminopropyltriethoxysilane were then added, and the mixture was kneaded under reduced pressure for 15 minutes to prepare Composition 5.

### Example 5

10 parts by weight of fumed silica (Aerosil R972 manufactured by Nippon Aerosil) having a specific surface area of 110 m²/g which had been surface treated with dimethyldichlorosilane was added to 100 parts by weight of the Synthetic product 2, and the mixture was kneaded in a planetary mixer at normal pressure for 10 minutes, and under reduced pressure for 20 minutes. 6 parts by weight of vinyltrimethylethyl ketoxime silane, 0.1 parts by weight of dioctyltin dilaurate, and 1 parts by weight of γ-aminopropyltriethoxysilane were then added, and the mixture was kneaded under reduced pressure for 15 minutes to prepare Composition 6.

### Example 6

10 parts by weight of fumed silica (Aerosil R972 manufactured by Nippon Aerosil) having a specific surface area of 110 m²/g which had been surface treated with dimethyldichlorosilane was added to 100 parts by weight of the Synthetic product 2, and the mixture was kneaded in a planetary mixer at normal pressure for 10 minutes, and under reduced pressure for 20 minutes. 4 parts by weight of vinyltrimethoxysilane, 3 parts by weight of tetrakis(2-ethylhexoxy) titanium, and 0.5 parts by weight of γ-glycidoxypropyltrimethoxysilane were then added, and the mixture was kneaded under reduced pressure for 15 minutes to prepare Composition 7.

### Comparative Example 2

6 parts by weight of vinyltriisopropenoxysilane, 0.7 parts by weight of tetramethylguanidylpropyltrimethoxysilane, and 0.5 parts by weight of γ-aminopropyltriethoxysilane were added to 100 parts by weight of the Synthetic product 2, and the mixture was kneaded under reduced pressure for 15 minutes to prepare Composition 8.

The resulting composition was placed in a metal tube, and heated to 80° C. In an environment of 23° C., the composition was formed into a sheet having a thickness of 2 mm, and the sheet was allowed to cure in an atmosphere of 23±2° C. at a relative humidity of 50±5% for 7 days. The resulting cured sheet was cut into squares of 3 cm×3 cm, and placed on an aluminum dish. After leaving the sheet in a drier kept at predetermined temperature for 7 days, shape of the sheet was examined. The results are shown in Table 2.

TABLE 2

| | | | | Comparative |
|---|---|---|---|---|
| | Example 4 | Example 5 | Example 6 | Example 2 |
| | Composition | Composition | Composition | Composition |
| | 5 | 6 | 7 | 8 |
| 23° C. | Shape | Shape | Shape | Shape |
| | retained | retained | retained | retained |
| 50° C. | Shape | Shape | Shape | Deformed |
| | retained | retained | retained | |
| 100° C. | Shape | Shape | Shape | Melted and |
| | retained | retained | retained | flowed away |
| 150° C. | Shape | Shape | Shape | Melted and |
| | retained | retained | retained | entirely lost |
| | | | | its shape |
| 200° C. | Shape | Shape | Shape | Melted and |
| | retained | retained | retained | entirely lost |
| | | | | its shape |

Japanese Patent Application No. 2007-244936 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A room temperature curable organopolysiloxane composition comprising
(A) 30 to 70 parts by weight of a diorganopolysiloxane endcapped at both ends of the molecular chain with hydroxy group represented by the following formula:
HO—(R₂SiO)ₙ—H
wherein R independently represents an unsubstituted or substituted monovalent hydrocarbon group, and n represents an integer of at least 10,
(B) 70 to 30 parts by weight of an organopolysiloxane comprising R¹₃SiO_{1/2} unit, R¹₂SiO_{2/2} unit, and R¹SiO_{3/2} unit wherein R¹ independently represents an unsubstituted or substituted monovalent hydrocarbon group containing 1 to 6 carbon atoms, and SiO4/2 unit with the proviso that molar ratio of R¹₃SiO_{1/2} unit to SiO_{4/2} unit is in the range of 0.6 to 1. 2, molar ratio of R¹₂SiO_{2/2} unit to SiO_{4/2} unit and molar ratio of R¹SiO_{3/2} unit to SiO_{4/2} unit are both in the range of 0 to 1.0, and content of the silanol group is less than 1.5% by weight,
(C) 2 to 50 parts by weight of surface treated fumed silica in relation to 100 parts by weight in total of the component (A) and component (B),
(D) 1 to 30 parts by weight of a silane and/or its hydrolysate containing at least two hydrolyzable groups in the molecule in relation to 100 parts by weight in total of the component (A) and component (B), and
(E) 0.01 to 10 parts by weight of a curing catalyst in relation to 100 parts by weight in total of the component (A) and component (B).

2. A room temperature curable organopolysiloxane composition according to claim 1 wherein surface treating agent used in preparing the surface treated fumed silica (C) is selected from chlorosilane, silazane, and siloxane, and the surface treated fumed silica has a specific surface area of 50 to 300 m²/g.

3. A room temperature curable organopolysiloxane composition according to claim 1 wherein the hydrolyzable group in the silane and/or its hydrolysate (D) containing at least two hydrolyzable groups in the molecule is an alkenoxy group.
